(19) United States
(12) Patent Application Publication
(10) Pub. No.: US 2018/0107829 A1
(43) Pub. Date: Apr. 19, 2018

(54) NETWORK ENTITY AND OPERATION METHOD OF THE SAME

(71) Applicant: Electronics and Telecommunications Research Institute, Daejeon (KR)

(72) Inventors: Changkyu LEE, Daejeon (KR); Wook HYUN, Daejeon (KR); Juyoung PARK, Daejeon (KR)

(73) Assignee: Electronics and Telecommunications Research Institute, Daejeon (KR)

(21) Appl. No.: 15/730,919

(22) Filed: Oct. 12, 2017

(30) Foreign Application Priority Data
Oct. 14, 2016 (KR) 10-2016-0133655
Sep. 5, 2017 (KR) 10-2017-0113092

(51) Int. Cl. G06F 21/62; G06F 21/60; H04L 29/06; G06F 21/10

(52) U.S. Cl. CPC G06F 21/62; G06F 21/604; H04N 21/231; G06F 21/10; H04L 63/10

(57) ABSTRACT

Disclosed is a network entity configured to receive a package access (PA) message associated with signaling for consuming a media package from a sending entity, verify, in response to a request for changing media data in the media package, whether the media data is changeable based on a flag in the PA message, change the media data and update the PA message when the media data is changeable, and transmit the changed media data and the updated PA message to a receiving entity.

### CROSS-REFERENCE TO RELATED APPLICATION(S)

This application claims the priority benefit of Korean Patent Application No. 10-2016-0133655 filed on Oct. 14, 2016 in the Korean Intellectual Property Office and Korean Patent Application No. 10-2017-0113092 filed on Sep. 5, 2017 in the Korean Intellectual Property Office, the disclosures of which are incorporated herein by reference for all purposes.

### BACKGROUND

### 1. Field

One or more example embodiments relate to a network entity.

### 2. Description of Related Art

A moving picture experts group (MPEG) media transport (MMT) may be classified into a media processing unit (MPU) function area associated with a logical structure and a physical file format of media data, a signaling function area associated with a signaling message for system operation and control, a delivery function area associated with a method of transmitting all types of data including the signaling message and media data, and a presentation information area associated with a method of representing a media data.

In a related art, a method and apparatus for controlling media transmission using a feedback of user equipment in a network, and a method and apparatus for optimizing media transmission based on a situation of user equipment in a media transmission system are disclosed in Korean Patent Laid-Open Publication No. 10-2015-0144322 (entitled: METHOD AND APPARATUS FOR CONTROLLING MEDIA DELIVERY IN MULTIMEDIA TRANSPORT NETWORK, Applicant: Samsung Electronics Co., Ltd.).

### SUMMARY

According to an aspect, there is provided an operation method of a network entity, the method including receiving a package access (PA) message associated with signaling for consuming a media package from a sending entity, verifying, in response to a request for changing media data in the media package, whether the media data is changeable based on information in the PA message, changing the media data and updating the PA message when the media data is changeable, and transmitting the changed media data and the updated PA message to a receiving entity.

The request may correspond to a change request message including an identifier of the media data.

The changing of the media data may include changing or replacing media data having an identifier included in the request to or with predetermined media data, and adding information associated with the predetermined media data to the PA message.

The information may correspond to a flag indicating whether the media data is to be replaced, modified, or changed by the network entity or another sending entity.

The operation method may further include transmitting, when the media data is changed to other media data, a feedback message including an identifier of the media data and an identifier of the other media data to the sending entity.

The operation method may further include receiving, from another sending entity, a request message requesting other media data to be inserted in the media package and the other media data, and inserting the other media data between pieces of media data in the media package based on start time information included in the request message.

The operation method may further include adding information associated with the other media data to the PA message.

The information associated with the other media data may include a number of pieces of the other media data.

According to another aspect, there is also provided a network entity including a communication interface and a controller coupled with the communication interface, wherein the controller is configured to receive a PA message associated with signaling for consuming a media package from a sending entity through the communication interface, verify, in response to a request for changing media data in the media package, whether the media data is changeable based on information in the PA message, change the media data and update the PA message when the media data is changeable, and transmit the changed media data and the updated PA message to a receiving entity through the communication interface.

The request may correspond to a change request message including an identifier of the media data.

The controller may be configured to change or replace media data having an identifier included in the request to or with predetermined media data, and add information associated with the predetermined media data to the PA message.

The information may correspond to a flag indicating whether the media data is to be replaced, modified, or changed by the network entity or another sending entity.

When the media data is changed to other media data, the controller may be configured to transmit a feedback message including an identifier of the media data and an identifier of the other media data to the sending entity through the communication interface.

The controller may be configured to receive a request message requesting other media data to be inserted in the media package and the other media data from another sending entity through the communication interface, and insert the other media data between pieces of media data in the media package based on start time information included in the request message.

The controller may be configured to add information associated with the other media data to the PA message.

The information associated with the other media data may include a number of pieces of the other media data.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an example of an operation of a moving picture experts group (MPEG) media transport (MMT) system according to an example embodiment;

FIG. 2A is a diagram illustrating a media data insertion according to an example embodiment;

FIG. 2B is a diagram illustrating a media data change according to an example embodiment;

FIGS. 3 and 4 are diagrams illustrating examples of a message according to an example embodiment;

FIGS. 5A and 5B are diagrams illustrating examples of a feedback according to an example embodiment;

FIG. 6 is a flowchart illustrating an operation method of a network entity according to an example embodiment; and

FIG. 7 is a block diagram illustrating a network entity according to an example embodiment.

### DETAILED DESCRIPTION

Hereinafter, some example embodiments will be described in detail with reference to the accompanying drawings.

It should be understood, however, that there is no intent to limit this disclosure to the particular example embodiments disclosed. On the contrary, example embodiments are to cover all modifications, equivalents, and alternatives falling within the scope of the example embodiments.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

Prior to describing example embodiments, terms are briefly described.

A media processing unit (MPU) may indicate a unit of media data to be independently consumed in a moving picture experts group (MPEG) media transport (MMT). An MPU identifier (ID) may be included in a header of the MPU.

An MMT asset or an asset may indicate a logical data object including at least one MPU. The MMT asset may include MPUs having the same asset ID.

An MMT package or a media package may include at least one MMT asset, MMT presentation information (PI), and MMT asset transport characteristics. The MMT PI may indicate a description about a spatial and temporal relationship between MMT assets. The MMT asset transport characteristics may indicate a description about a quality of service (QoS) required for transmission of the MMT asset.

An MMT protocol (MMTP) may be an application layer protocol for transmitting an MMT payload.

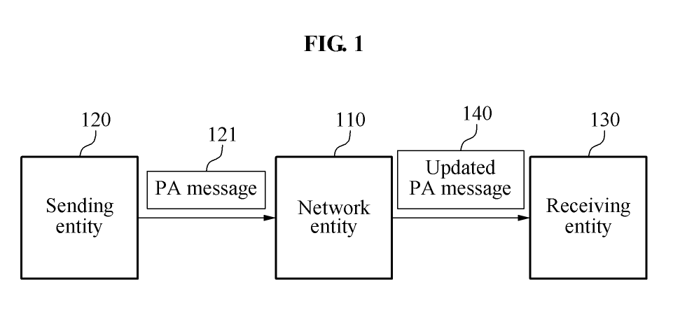

FIG. 1 is a diagram illustrating an operation of an MMT system according to an example embodiment.

Referring to FIG. 1, an MMT system may include a network entity 110, a sending entity 120, and a receiving entity 130.

The network entity 110, the sending entity 120, and the receiving entity 130 may support an MMTP. In this example, the network entity 110 may correspond to a media aware network entity or an MMT aware network entity (MANE), the sending entity 120 may correspond to an MMT sending entity, and the receiving entity 130 may correspond to an MMT receiving entity.

The network entity 110 may transmit a media package received from the sending entity 120 or another sending entity to the receiving entity 130, or transmit its own media package to the receiving entity 130. Also, the network entity 110 may transmit a predetermined asset included in a media package to the receiving entity 130. For example, the network entity 110 may transmit an MMTP packet generated by packetizing an MPU included in the asset to the receiving entity 130.

The media package may be, for example, a movie. The asset may be, for example, a sound or an image of the movie.

The network entity 110 may receive a package access (PA) message 121 from the sending entity 120. Here, the PA message 121 may include information used by the receiving entity 130 to consume the media package or the asset. The PA message 121 may include an MMT package (MP) table. The MP table may include, for example, a number of assets included in a package and an asset ID of each of the assets.

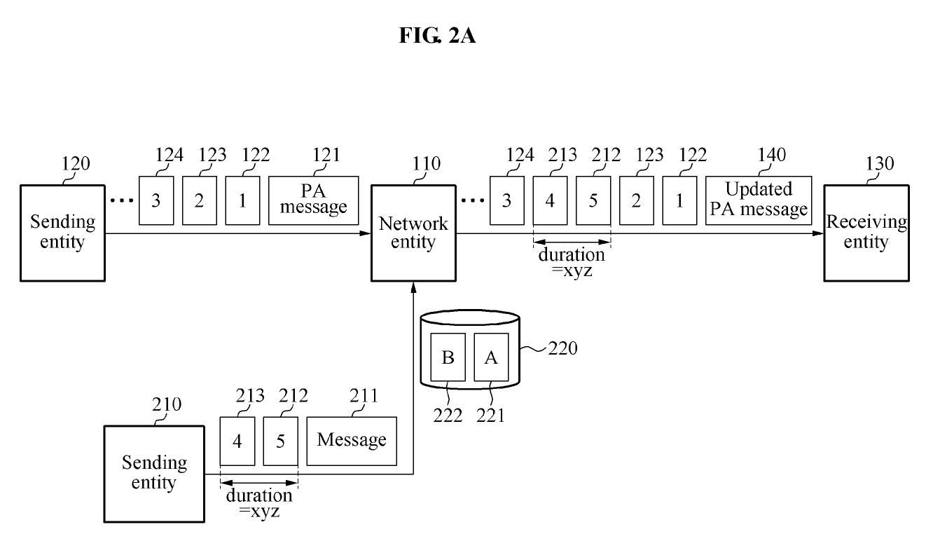

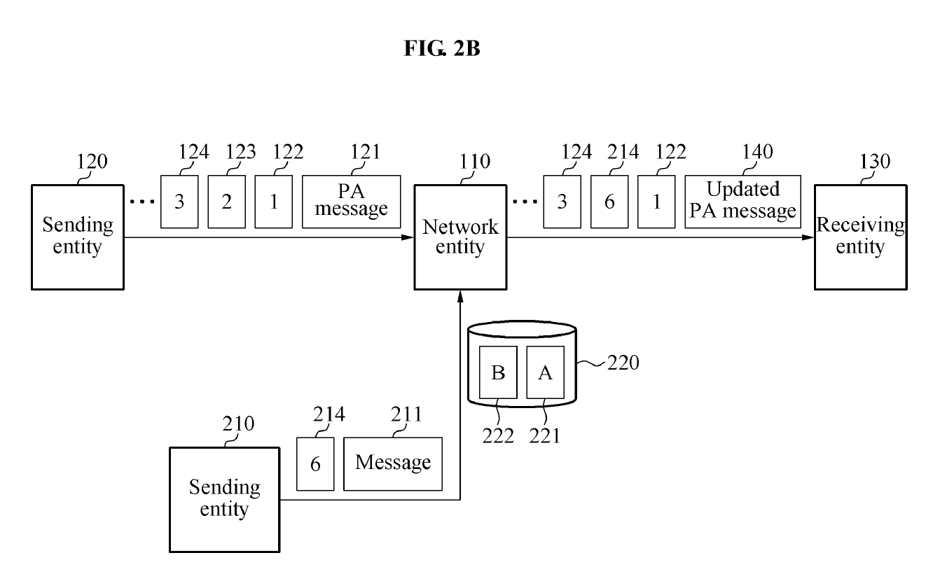

While the media package is transmitted to the receiving entity 130, the network entity 110 may insert media data in the media package in response to an insertion request, and related description will be provided with reference to FIG. 2A. Also, while the media package is transmitted to the receiving entity 130, in response to a request for changing predetermined media data in the media package, the network entity 110 may change or replace the media data to or with other media data, or modify the media data. Related description will be provided with reference to FIG. 2B.

The media data may indicate the MPU, the asset, or the MMTP packet.

When the media data is inserted, changed, modified, or replaced, the network entity 110 may update or modify the PA message 121. For example, the network entity 110 may update or modify the MP table included in the PA message 121.

The network entity 110 may transmit the changed media data and an updated PA message 140 to the receiving entity 130.

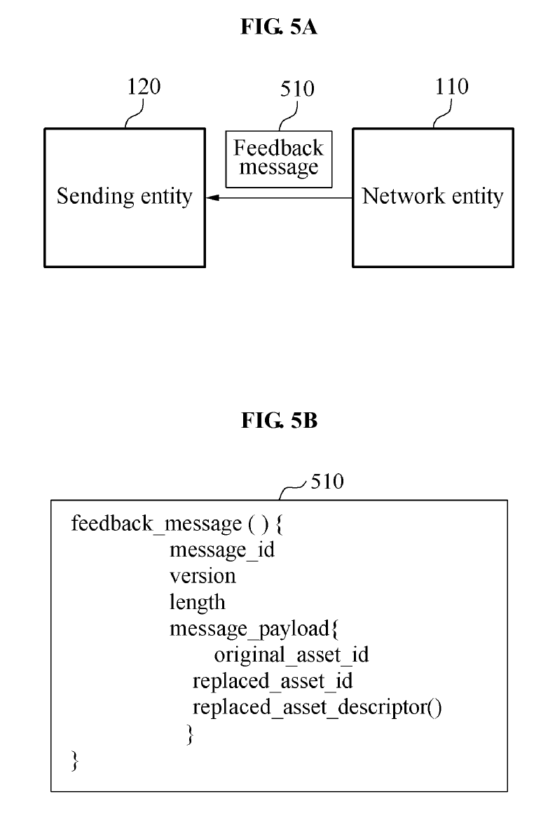

When the media data is added, changed, modified, or replaced, the network entity 110 may transmit a feedback message to the sending entity 120. Related description will be provided with reference to FIG. 5.

<Media Data Insertion>

FIG. 2A is a diagram illustrating a media data insertion according to an example embodiment.

Referring to FIG. 2A, the network entity 110 may receive the PA message 121 and media data 122 through media data 124 from the sending entity 120. In an example of FIG. 2A, an ID of the media data 122 is “1”, an ID of the media data 123 is “2”, and an ID of the media data 124 is “3”.

As described with reference to FIG. 1, the PA message 121 may include an MP table.

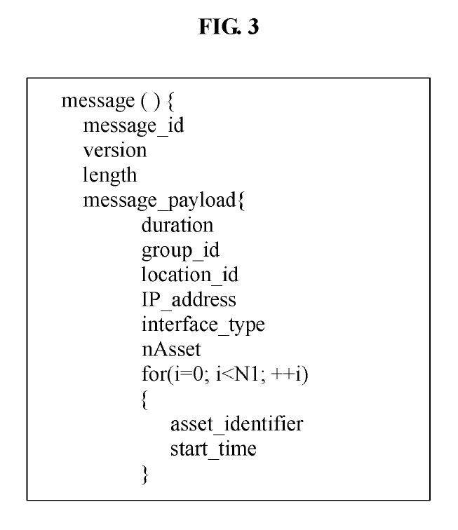

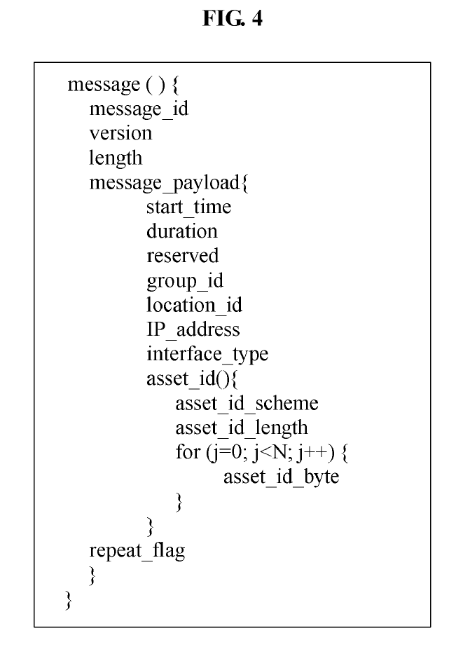

The network entity 110 may transmit a media package including the media data 122 through the media data 124 to the receiving entity 130. In response to an insertion request, the network entity 110 may insert media data in the media package and update the PA message 121. In the example of FIG. 2A, the network entity 110 may receive a message 211 including the insertion request, media data 212, and media data 213 from another sending entity, for example, a sending entity 210. Here, the message 211 may include “5” corresponding to an ID of the media data 212 and a playback start time of the media data 212, and “4” corresponding to an ID of the media data 213 and a playback start time of the media data 213. The message 211 will be also described with reference to FIGS. 3 and 4.

When the network entity 110 receives the message 211, for example, when the insertion request is sent from the sending entity 210, the network entity 110 may determine a position to which each of the media data 212 and the media data 213 received from the sending entity 210 is to be inserted. Concisely, the network entity 110 may determine an insertion position of each of the media data 212 and the media data 213. For example, the network entity 110 may reference the message 211 to verify playback start times of the media data 212 and the media data 213, and determine the insertion positions of the media data 212 and the media data 213 based on the playback start times of the media data 212 and the media data 213 and playback start times of the media data 122 through the media data 124. In the example of FIG. 2A, the playback start times of the media data 212 and the media data 213 may be later than the playback start time of the media data 123 and earlier than the playback start time of the media data 124. The network entity 110 may insert the media data 212 and the media data 213 between the media data 123 and the media data 124. As such, the network entity 110 may determine the insertion positions of the media data 212 and the media data 213 in the media package based on the playback start times of the media data 212 and the media data 213.

When the media data 212 and the media data 213 are inserted, the network entity 110 may update or modify the PA message 121 based on the message 211. Specifically, the network entity 110 may update an MP table in the PA message 121 based on data in the message 211. The MP table may include a number of assets in a media package transmitted to the receiving entity 130. The message 211 may include a number of assets to be inserted. The network entity 110 may update “the number of assets in the media package” in the MP table based on “the number of assets to be inserted” in the message 211. When “the number of assets in the media package” is 100, and when “the number of assets to be inserted” is 2, the network entity 110 map update “a total number of assets in the media package” to be 102. Also, the network entity 110 may add an ID of an inserted asset to the MP table.

An ID of the media data 221 and/or the media data 222 transmitted from the sending entity 210 to the network entity 110 may be the same as an ID of one piece of the media data in the media package of the sending entity 120. Since the sending entity 210 is unaware of IDs of the media data 122 through 124 transmitted by the sending entity 120, an ID of at least one of the media data 212 and the media data 213 transmitted from the sending entity 210 to the network entity 110 may be the same as an ID of media data transmitted from the sending entity 120 to the network entity 110. For example, an ID of media data (not shown) transmitted from the sending entity 120 to the network entity 110 may be “4” and the same as the ID of the media data 213 transmitted from the sending entity 210 to the network entity 110. In this example, the network entity 110 may modify the ID of the media data 213 such that the ID of the media data (not shown) transmitted from the sending entity 120 to the network entity 110 does not overlap the ID of the media data 213. The network entity 110 may add the modified ID to the PA message 121 or the MP table of the PA message 121. Also, the network entity 110 may modify packet_id of an MMTP packet including the media data 213.

The sending entity 210 may acquire information on an asset transmitted or to be transmitted by the sending entity 120. The sending entity 210 may set the ID of the media data 212 and/or the media data 213 such that the IDs of the media data 212 and the media data 213 transmitted from the sending entity 210 to the network entity 110 does not overlap the IDs of the media data 122 through the media data 124 transmitted from the sending entity 120 to the network entity 110.

When a media insertion or a video insertion occurs and the PA message 121 is updated, the network entity 110 may transmit the media package including the media data 212 and the media data 213 and the updated PA message 140 to the receiving entity 130. The receiving entity 130 may consume the media package based on the updated PA message 140.

When the media data 122 through the media data 124 correspond to a broadcast image and the media data 212 and the media data 213 correspond to an advertisement, the network entity 110 may perform streaming by inserting the advertisement into the broadcast image.

In the example of FIG. 2A, the network entity 110 may insert the media data 212 and the media data 213 of the sending entity 210 in response to the insertion request from the sending entity 210. In another example, when the network entity 110 determines that an insertion is required, the network entity 110 may insert media data 221 and/or media data 222 stored in a storage 220 into a media package. In still another example, the network entity 110 may receive a message including an insertion request, position information of media data to be inserted, and playback start time information of the media data to be inserted, from the sending entity 120 or the sending entity 210. In this example, the network entity 110 may retrieve media data by accessing based on the position information and insert media data based on the playback start time information included in the received message.

As further discussed in FIG. 5, the network entity 110 may transmit a feedback message indicating that the media data is inserted to the sending entity 120.

<Media Data Change>

FIG. 2B is a diagram illustrating a media data change according to an example embodiment.

Referring to FIG. 2B, the network entity 110 may receive the PA message 121 and the media data 122 through the media data 124 from the sending entity 120. An MP table in the PA message 121 may include a flag indicating whether each of the media data 122 through the media data 124 is to be changed, modified, or replaced. In an example of FIG. 2B, the flags of the media data 122 and the media data 124 may indicate that the media data 122 and the media data 124 are not to be changed, modified, and replaced. Also, the flag of the media data 123 may indicate that the media data 123 is to be changed, modified, or replaced. Concisely, the media data 122 and the media data 124 may not be changed, modified, and replaced, and the media data 123 may be changed, modified, or replaced.

In response to a request for changing predetermined media data, the network entity 110 may verify whether the media data is changeable by referencing a flag of the media data. When the media data is changeable, the network entity 110 may change the media data. Also, the network entity 110 may update the PA message 211.

In the example of FIG. 2B, the network entity 110 may receive the message 211 and media data 214 from the sending entity 210. In this example, the message 211 may include a change request and an ID of predetermined media data. When the media data 123 is to be changed to the media data 214, the sending entity 210 may incorporate a change request and an ID of the media data 123 in the message 211 and transmit the message 211 to the network entity 110. Here, the ID of the media data 123 may be, for example, “2”.

When the media data 214 and the message 211 including the change request and the ID of the media data 123 are received, the network entity 110 may verify whether the media data 123 is changeable based on the flag of the media data 123 included in the PA message 121. In the example of FIG. 2B, since the media data 123 is changeable, the network entity 110 may change the media data 123 to the media data 214 or overlay the media data 214 on the media data 123. Also, the network entity 110 may add the ID of the media data 214 to the NIP table.

When the media data 123 is not changeable, and when the media data 214 and the message 211 including the change request and the ID of the media data 123 are received, the network entity 110 may not change the media data 123 to the media data 214.

The network entity 110 may transmit the updated PA message 140, the media data 122, the media data 214, and the media data 124 to the receiving entity 130.

In the example of FIG. 2B, the network entity 110 may change or replace the media data 123 to or with the media data 214 of the sending entity 210 in response to a change request from the sending entity 210. In another example, the network entity 110 may change the media data 123 corresponding to changeable data to the media data 221 and/or the media data 222 stored in the storage 220. In still another example, the network entity 110 may receive a message including a change request, an ID of predetermined media data, and position information of other media data from the sending entity 120 or the sending entity 210. In this example, the network entity 110 may retrieve media data by accessing based on the position information and change the predetermined media data to the media data.

As further discussed in FIG. 5, the network entity 110 may transmit a feedback message indicating that the media data is changed to the sending entity 120.

FIGS. 3 and 4 are diagrams illustrating examples of the message 211 of FIGS. 2A and 2B

FIG. 3 illustrates an example of the message 211.

Referring to FIG. 3, the message 211 may include a message_id field, a version field, a length field, a duration field, a group_id field, a location_id field, an IP_address field, an interface_type field, an nAsset field, an asset_identifier field, and a start_time field. Also, the message 211 may further include a request type filed. In the request type field, the insertion request of FIG. 2A or the change request of FIG. 2B may be set.

The message_id field may indicate an identifier of the message 211.

The version field may indicate a version of the message 211. The receiving entity 130 may verify whether the message 211 is new based on the version field.

The length field may indicate a length of the message 211. In the length field, a length from the duration field to the start_time field may be set.

The duration field may indicate a duration of a media insertion or a video insertion. When the duration field is set to 0, the duration of the media insertion may be the same as a duration of an inserted media. In the example of FIG. 2A, since a duration of the media data 212 and 213 to be inserted is “xyz”, the sending entity 210 may set “xyz” in the duration field. In the example of FIG. 2B, in the duration field, a length or a duration of the media data 214 or 0 may be set. For example, when the length or the duration of the media data 214 is “abc”, the sending entity 210 may set “abc” or 0 in the duration field.

The group_id field may indicate group information. The group information may be associated with, for example, a mobile station international integrated services digital network (ISDN) number (MSISDN).

The location_id field may indicate a type of a location. The location may be associated with, for example, a cell ID, global positioning system (GPS), or Internet protocol (IP).

The IP_address field may indicate an IP address of the sending entity 120 that transmits an asset to be inserted. Here, the asset to be inserted may correspond to an added asset as described above.

The interface_type field may indicate a network interface type. The network interface type may include a module network, for example, a wireless fidelity (WiFi) or a long term evolution (LTE).

The nAsset field may indicate a number of assets to be inserted. In the example of FIG. 2, the sending entity 210 may set “2” in the nAsset field.

The asset_identifier field may indicate an identifier of an asset to be inserted. In the example of FIG. 2A, the sending entity 210 may set “5” corresponding to an ID of the media data 212 and “4” corresponding to an ID of the media data 213 in the asset_identifier field.

The start_time field may represent a playback start_time of an asset to be inserted. In the example of FIG. 2A, the sending entity 210 may set a playback start time of the media data 212 and a playback start time of the media data 213 in the start_time field.

Depending on an example, the nAsset field may indicate a number of assets to be changed, and the asset_identifier field may indicate an identifier of an asset to be changed. In the example of FIG. 2B, since one piece of media data is to be changed, the sending entity 210 may set “1” in the nAsset field. Also, the sending entity 210 may set “2” that is an ID of the media data 123 to be changed in the asset_identifier field. When the message 211 including the nAsset field set to “1” and the asset_identifier field set to “2” is received from the sending entity 210, the network entity 110 may verify whether the media data 123 is changeable based on a flag of the media data 123 having an asset ID of 2. When the media data 123 is changeable, the network entity may change the media data 123 to other media data. Here, the other media data may be media data corresponding to position information included in the message 211 or the media data 214 of the sending entity 210.

In the example of FIG. 3, the message 211 may also include any one or any combination of the message_id field, the version field, the length field, the duration field, the group_id field, the location_id field, the IP_address field, the interface_type field, the nAsset field, the asset_identifier field, and the start_time field.

FIG. 4 illustrates another example of the message 211.

Referring to FIG. 4, the message 211 may include an asset_id_scheme field, an asset_id_length field, and a repeat_flag in comparison to the example of FIG. 3. However, the example of the message 211 is not limited thereto. In FIG. 4, the message 211 may also include any one or any combination of the asset_id_scheme field, the asset_id_length field, and the repeat_flag field.

The asset_id_scheme field may indicate a scheme of an ID of an asset to be inserted or an asset to be changed.

The asset_id_length field may indicate a length of the asset to be inserted or the asset to be changed.

The repeat_flag field may indicate whether the asset to be inserted or the asset to be changed is to be replayed in a subsequent insertion. In the example of FIG. 2A, when the repeat_flag field in the message 211 is set to be “1”, the network entity 110 may store the media data 212 and the media data 213 determined in the message 211 and insert store the media data 212 and the media data 213 in another media package.

FIGS. 5A and 5B are diagrams illustrating a feedback according to an example embodiment.

Referring to FIG. 5A, the network entity 110 may transmit a feedback message 510 to the sending entity 120. As described with reference to FIG. 2A, when the network entity 110 inserts media data in a media package of the sending entity 120, the network entity 110 may transmit the feedback message 510 to the sending entity 120. The feedback message 510 may include a number of pieces of inserted media data and a duration or length of inserted media data. In the example of FIG. 2A, the network entity 110 may insert two pieces of media data, the media data 212 and the media data 213, and a duration of the inserted media data is “xyz”. Thus, the feedback message 510 including “the number of pieces of inserted data media=2” and “duration=xyz” may be transmitted to the sending entity 120. The sending entity 120 may receive the feedback message 510 and acknowledge that the media data is inserted to the media package of the sending entity 120.

As described with reference to FIG. 2B, when the network entity 110 changes, modifies, or replaces media data of the sending entity 120, the network entity 110 may transmit the feedback message 510 to the sending entity 120. The feedback message 510 may include information associated with media data that is changed, replaced, or modified. In the example of FIG. 2B, the network entity 110 may change or replace the media data 123 to or with the media data 214. Thus, the feedback message 510 including the ID of the media data 123 and the ID of the media data 214 may be transmitted to the sending entity 120. The sending entity 120 may receive the feedback message 510 to acknowledge media data which is removed from media data of the sending entity 120 and acknowledge media data which is added instead of the media data of the sending entity 120.

Hereinafter, the feedback message 510 will be described with reference to FIG. 5B.

Referring to FIG. 5B, the feedback message 510 may include a message_id field, a version field, a length field, an original_asset_id field, a replaced_asset_id field, and a replaced_asset_descriptor field. The original_asset_id field, the replaced_asset_id field, and the replaced_asset_descriptor field may be included in a payload.

The message_id field may indicate an identifier of the feedback message 510.

The version field may indicate a version of the feedback message 510. The sending entity 120 may verify whether the feedback message 510 is new based on the version field.

The length field may indicate a length of the feedback message 510. In the length field, a length from the replaced_asset_descriptor field to the original_asset_id field or the duration field may be set.

The original_asset_id field may indicate an identifier of an asset removed by an intermediate node. The intermediate node may include the network entity 110. The identifier set in the original_asset_id field may be the same as an identifier set in the asset_identifier field of the message 211.

In the example of FIG. 2A, when a removed asset or removed media data is absent, the network entity 110 may not set or record an identifier in the original_asset_id field. In the example of FIG. 2B, when a removed asset or removed media data is present, the network entity 110 may set or record “2” corresponding to the ID of the media data 123 that is removed, in the original_asset_id field.

The replaced_asset_id field may indicate an identifier of an asset inserted by the intermediate mode. In the example of FIG. 2A, since the media data 212 and the media data 213 are inserted, the network entity 110 may set or record “4” corresponding to the ID of the media data 212 and “5” corresponding to the ID of the media data 213 in the replaced_asset_id field. In the example of FIG. 2B, since the media data 214 is added, the network entity 110 may set or record “6” corresponding to the ID of the media data 214 in the replaced_asset_id field.

The replaced_asset_descriptor field may include detailed information about an added asset or added data.

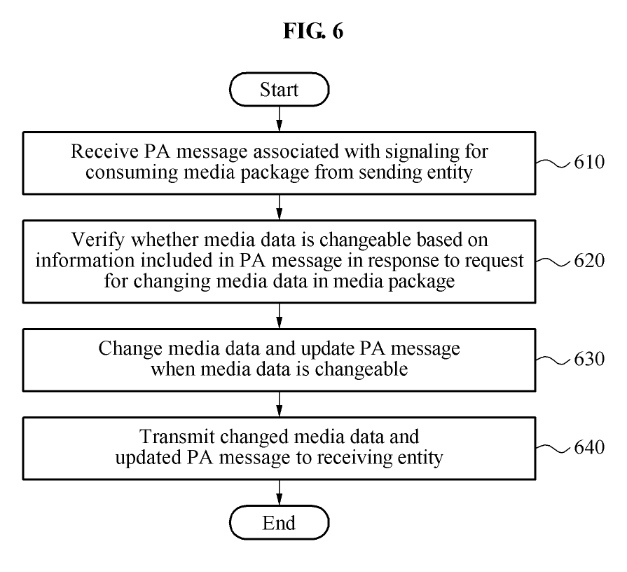

FIG. 6 is a flowchart illustrating an operation method of a network entity according to an example embodiment.

Referring to FIG. 6, in operation 610, the network entity 110 receives the PA message 121 associated with signaling for consuming a media package from the sending entity 120.

In operation 620, in response to a request for changing media data in the media package, the network entity 110 may verify whether the media data is changeable based on information included in the PA message 121. In this example, the request may correspond to the message 211. Also, the information may correspond to a flag indicating whether an asset is to be replaced, modified, or changed by the network entity 110 or another sending entity.

In operation 630, when the media data is changeable, the network entity 110 may change the media data and update the PA message 121.

In operation 640, the network entity 110 may transmit the changed media data and the updated PA message 140 to the receiving entity 130.

Since the description of FIGS. 1 through 5B is also applicable to FIG. 6, repeated description will be omitted for brevity.

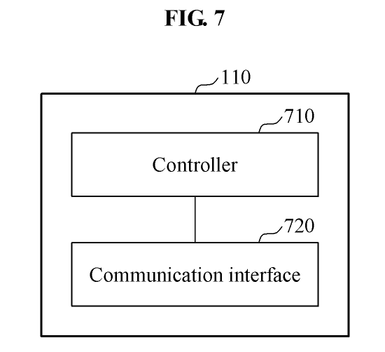

FIG. 7 is a block diagram illustrating a network entity according to an example embodiment.

Referring to FIG. 7, the network entity 110 may include a controller 710 and a communication interface 720.

The controller 710 may be coupled with the communication interface 720.

The controller 710 may receive the PA message 121 associated with signaling for consuming a media package from the sending entity 120 through the communication interface 720.

In response to a request for changing media data in the media package, the controller 710 may verify whether the media data is changeable based on information in the PA message 121.

When the media data is changeable, the controller 710 may change the media data and update the PA message 121.

The controller 710 may transmit the changed media data and the updated PA message 140.

Since the description of FIGS. 1 through 5B is also applicable to FIG. 7, repeated description will be omitted for brevity.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An operation method of a network entity, the method comprising:
receiving a package access (PA) message associated with signaling for consuming a media package from a sending entity;
verifying, in response to a request for changing media data in the media package, whether the media data is changeable based on information in the PA message;
changing the media data and updating the PA message when the media data is changeable; and
transmitting the changed media data and the updated PA message to a receiving entity.

2. The operation method of claim 1, wherein the request corresponds to a change request message including an identifier of the media data.

3. The operation method of claim 1, wherein the changing of the media data comprises changing or replacing media data having an identifier included in the request to or with predetermined media data, and adding information associated with the predetermined media data to the PA message.

4. The operation method of claim 1, wherein the information corresponds to a flag indicating whether the media data is to be replaced, modified, or changed by the network entity or another sending entity.

5. The operation method of claim 1, further comprising:
transmitting, when the media data is changed to other media data, a feedback message including an identifier of the media data and an identifier of the other media data to the sending entity.

6. The operation method of claim 1, further comprising:
receiving, from another sending entity, a request message requesting other media data to be inserted in the media package and the other media data; and
inserting the other media data between pieces of media data in the media package based on start time information included in the request message.

7. The operation method of claim 6, further comprising:
adding information associated with the other media data to the PA message.

8. The operation method of claim 7, wherein the information associated with the other media data includes a number of pieces of the other media data.

9. A network entity comprising:
a communication interface; and
a controller coupled with the communication interface,
wherein the controller is configured to receive a package access (PA) message associated with signaling for consuming a media package from a sending entity through the communication interface, verify, in response to a request for changing media data in the media package, whether the media data is changeable based on information in the PA message, change the media data and update the PA message when the media data is changeable, and transmit the changed media data and the updated PA message to a receiving entity through the communication interface.

10. The network entity of claim 9, wherein the request corresponds to a change request message including an identifier of the media data.

11. The network entity of claim 9, wherein the controller is configured to change or replace media data having an identifier included in the request to or with predetermined media data, and add information associated with the predetermined media data to the PA message.

12. The network entity of claim 9, wherein the information corresponds to a flag indicating whether the media data is to be replaced, modified, or changed by the network entity or another sending entity.

13. The network entity of claim 9, wherein, when the media data is changed to other media data, the controller is configured to transmit a feedback message including an identifier of the media data and an identifier of the other media data to the sending entity through the communication interface.

14. The network entity of claim 9, wherein the controller is configured to receive a request message requesting other media data to be inserted in the media package and the other media data from another sending entity through the communication interface, and insert the other media data between pieces of media data in the media package based on start time information included in the request message.

15. The network entity of claim 14, wherein the controller is configured to add information associated with the other media data to the PA message.

16. The network entity of claim 15, wherein the information associated with the other media data includes a number of pieces of the other media data.
